(19) United States
(12) Patent Application Publication
(10) Pub. No.: US 2025/0242667 A1
(43) Pub. Date: Jul. 31, 2025

(54) AIR PASSAGE STRUCTURE

(71) Applicant: Honda Motor Co., Ltd., Tokyo (JP)

(72) Inventor: Yu NAKASHIMA, Tokyo (JP)

(73) Assignee: Honda Motor Co., Ltd., Tokyo (JP)

(21) Appl. No.: 18/977,992

(22) Filed: Dec. 12, 2024

(30) Foreign Application Priority Data
Jan. 26, 2024 (CN) 202410110748.0
Jul. 10, 2024 (CN) 202410922781.3

(51) Int. Cl. B60H 1/34

(52) U.S. Cl. CPC B60H 1/3421; B60H 1/345

(57) ABSTRACT

Provided is an air passage structure which may well control the wind direction and improve the degree of freedom of internal component configuration. The air passage structure includes a ventilation path, extending along a first direction; a pair of inlet portions, disposed in the ventilation path to allow air to enter the ventilation path; an outlet portion, disposed between the pair of inlet portions in the ventilation path to allow the air to exit the ventilation path; and a movable mechanism, disposed at the outlet portion and being movable toward the first direction.

### CROSS-REFERENCE TO RELATED APPLICATION

This application claims the priority benefit of China application serial no. 202410110748.0, filed on Jan. 26, 2024, and China application serial no. 202410922781.3, filed on Jul. 10, 2024. The entirety of each of the above-mentioned patent applications is hereby incorporated by reference herein and made a part of this specification.

### BACKGROUND

### Technical Field

The disclosure relates to an air passage structure.

### Description of Related Art

In order to enable disadvantaged groups such as the elderly, the disabled, and children to use sustainable transportation systems, commitments have been made to provide transportation with greater vehicle comfort. In the prior art, the air conditioner in the vehicle discharges air in a variety of ways, the most common of which is to set a wind direction adjustment plate to control the flow direction of the air. With the pursuit of aesthetics, there is also an air guide structure with a hidden wind direction adjustment plate, which makes the originally visible blades or plates hidden in a part that is invisible to users. However, this solution has a higher technical threshold for controlling the wind direction. If the appropriate air passage structure cannot be designed, it will be difficult to control the wind direction of the air outlet. The disclosure provides a solution to control wind direction, thereby improving vehicle comfort and helping to develop a sustainable transportation system.

### SUMMARY

The disclosure provides an air passage structure which may well control the wind direction and improve the degree of freedom of internal component configuration.

An air passage structure of the disclosure includes a ventilation path, extending along a first direction; a pair of inlet portions, disposed in the ventilation path to allow air to enter the ventilation path; an outlet portion, disposed between the pair of inlet portions in the ventilation path to allow the air to exit the ventilation path; and a movable mechanism, disposed at the outlet portion and being movable toward the first direction.

Based on the above, in the air passage structure of the disclosure, the outlet portion is disposed between a pair of inlet portions in the ventilation path, and the outlet portion is disposed with a movable mechanism to reliably control the flow direction of the air in the first direction. Furthermore, the space between the pair of inlet portions and outside the ventilation path may be used to place components not related to air conditioning, thereby increasing the space and degree of freedom for component configuration. Accordingly, the air passage structure of the disclosure may well control the wind direction and improve the degree of freedom of internal component configuration.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic perspective view of an air passage structure according to an embodiment of the disclosure.
(a) of FIG. 2 and (b) of FIG. 2 are schematic cross-sectional views of the air passage structure of FIG. 1 along the B-B and C-C section lines, respectively.
(a) of FIG. 3 and (b) of FIG. 3 are top views of the first ventilation path and the second ventilation path in the air passage structure of FIG. 1, and (c) of FIG. 3 is a front view of the air passage structure of FIG. 1.

FIG. 4 is a schematic view of the movable mechanism of FIG. 3 after movement.

FIG. 5 and FIG. 6 are schematic views of the adjustment mechanism of FIG. 2 and FIG. 3 after movement.

FIG. 7 is a schematic view of the movable mechanism of FIG. 6 after movement.

FIG. 8 and FIG. 9 are schematic views of the adjustment mechanism of FIG. 2 and FIG. 3 after movement.

FIG. 10 is a schematic view of the movable mechanism of FIG. 9 after movement.

FIG. 11 is a schematic exploded view of the movable mechanism used in the air passage structure of FIG. 1.

FIG. 12 is a partial enlarged schematic view of the movable mechanism of FIG. 11.

FIG. 13 is a schematic view of an operating state of the movable mechanism of FIG. 12.

### DESCRIPTION OF THE EMBODIMENTS

In an embodiment of the disclosure, the ventilation path includes at least two ventilation paths, a first ventilation path and a second ventilation path, and an adjustment mechanism for adjusting the amount of air entering the first ventilation path and the second ventilation path. The outlet portion includes a first outlet disposed in the first ventilation path and a second outlet disposed in the second ventilation path, and the first outlet and the second outlet are disposed to overlap in a second direction orthogonal to the first direction and the direction in which the air exits the outlet portion.

In an embodiment of the disclosure, the pair of inlet portions are respectively disposed with the adjustment mechanism, and the adjustment mechanism of one of the pair of inlet portions makes the air entering the first ventilation path larger than the air entering the second ventilation path, while the adjustment mechanism of the other of the pair of inlet portions makes the air entering the first ventilation path smaller than the air entering the second ventilation path.

In an embodiment of the disclosure, the movable mechanism includes a first movable portion disposed on one side of the first direction and a second movable portion disposed on the other side, and the first movable portion and the second movable portion face different directions respectively.

In an embodiment of the disclosure, the first outlet of the first ventilation path faces downward, the second outlet of the second ventilation path faces upward, and the movable mechanism of the first ventilation path diffuses the air, while the movable mechanism of the second ventilation path concentrates the air.

In an embodiment of the disclosure, the first movable portion of the first ventilation path faces the one side in the first direction, the second movable portion of the first ventilation path faces the other side in the first direction, the first movable portion of the second ventilation path faces the one side in the first direction, and the second movable portion of the second ventilation path faces the other side in the first direction.

In an embodiment of the disclosure, the first movable portion and the second movable portion are driven by a single driving mechanism.

In an embodiment of the disclosure, the driving mechanism includes a driving motor, a first link connected to the first movable portion, a second link connected to the second movable portion, and an engaging member engaged with the first link and the second link and rotated by the driving motor.

In an embodiment of the disclosure, the engaging member includes a first engaging portion engaged with the first link and the second link, and a second engaging portion engaged with only the first link.

In an embodiment of the disclosure, the first link has a first groove for the first engaging portion to be inserted into, the second link has a second groove for the first engaging portion to be inserted into, and a length of the first groove is longer than a length of the second groove.

In an embodiment of the disclosure, the ventilation path is formed with a convex portion protruding toward the outlet portion, and a vertex of the convex portion serves as a boundary position dividing the first movable portion and the second movable portion in the first direction.

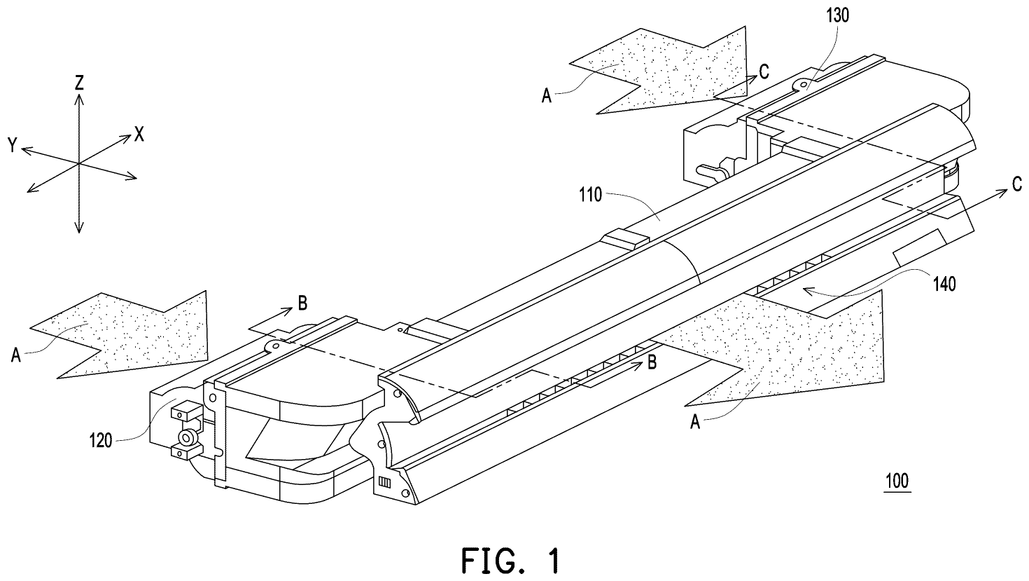

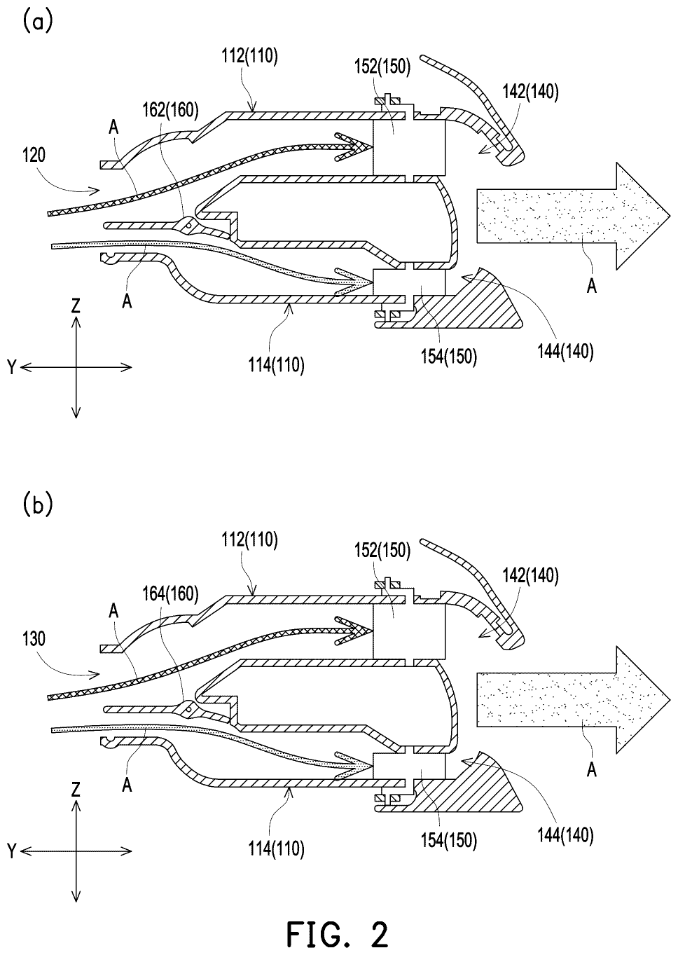

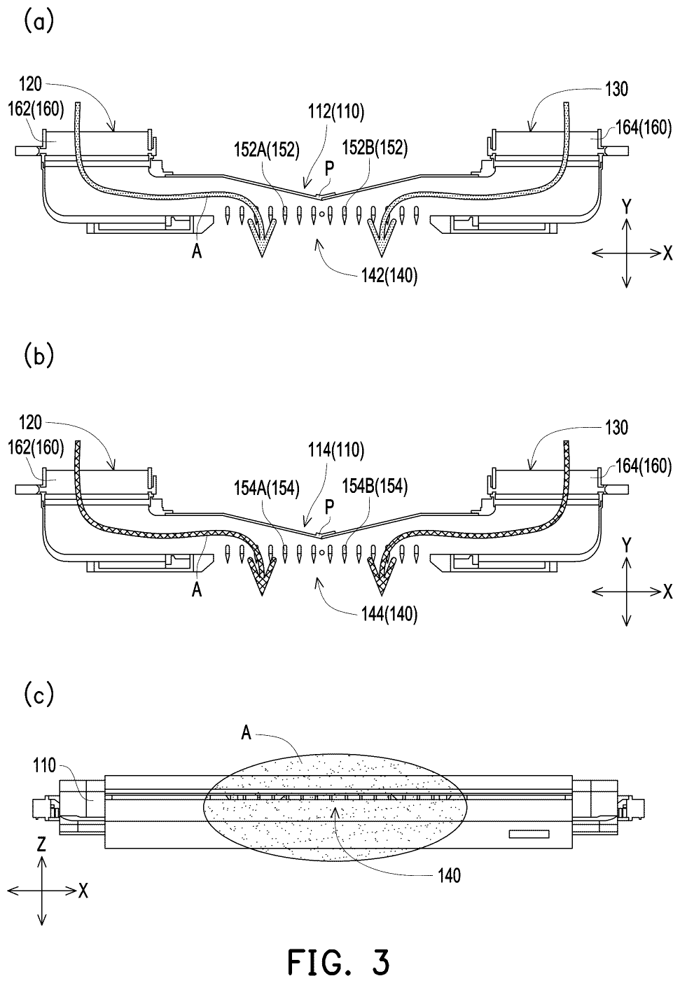

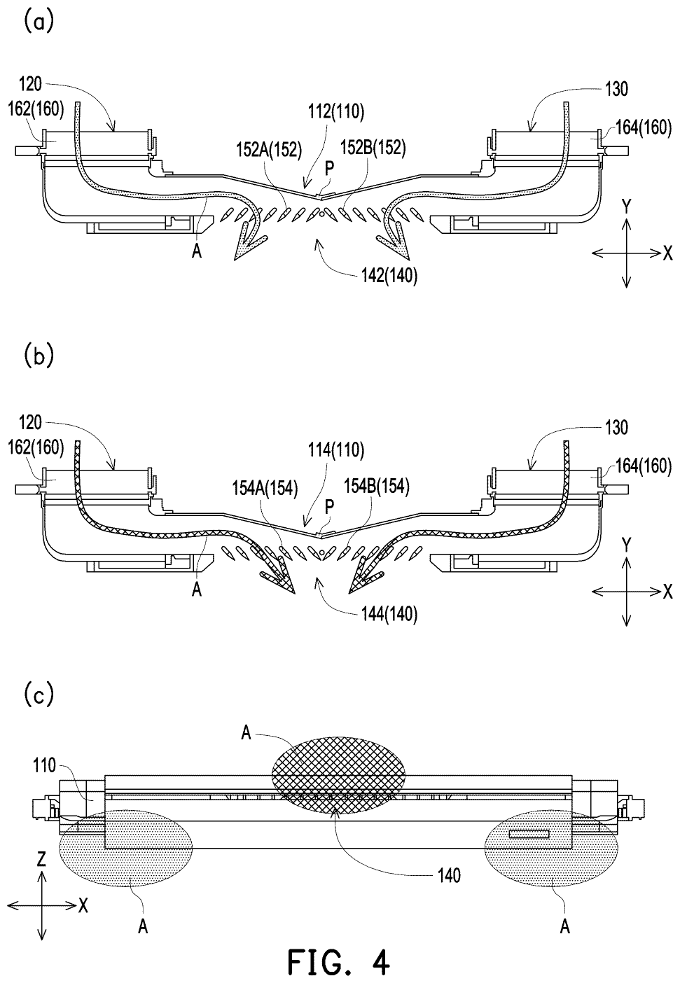

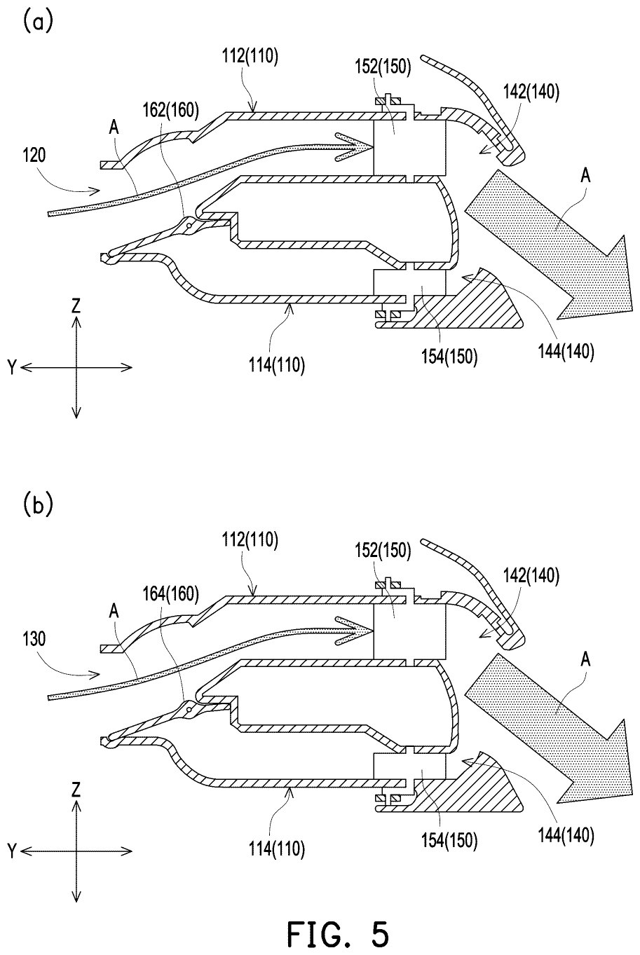

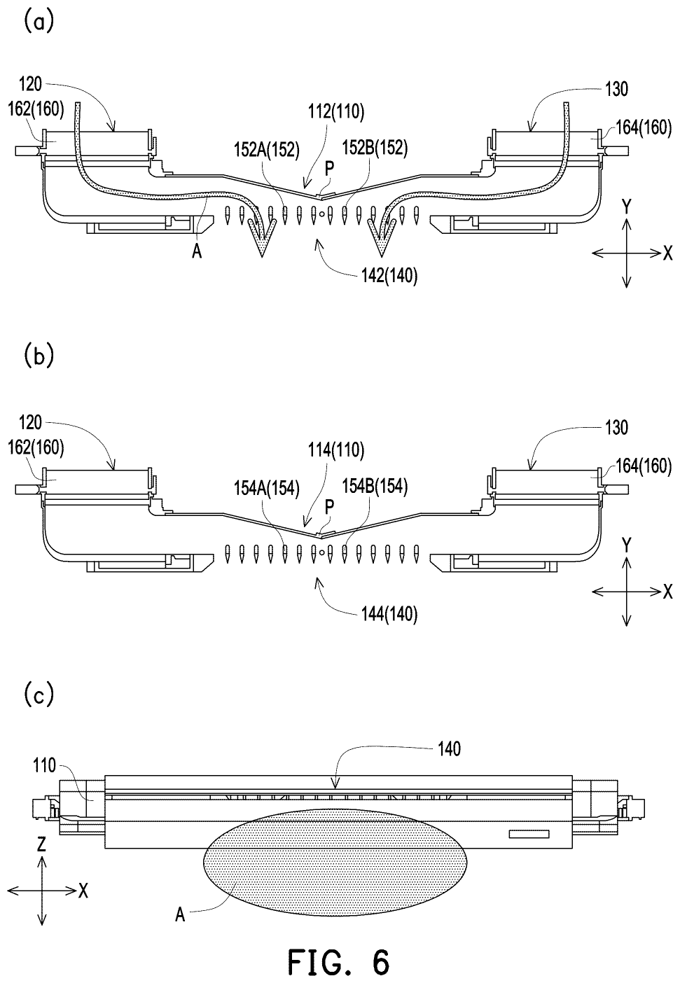

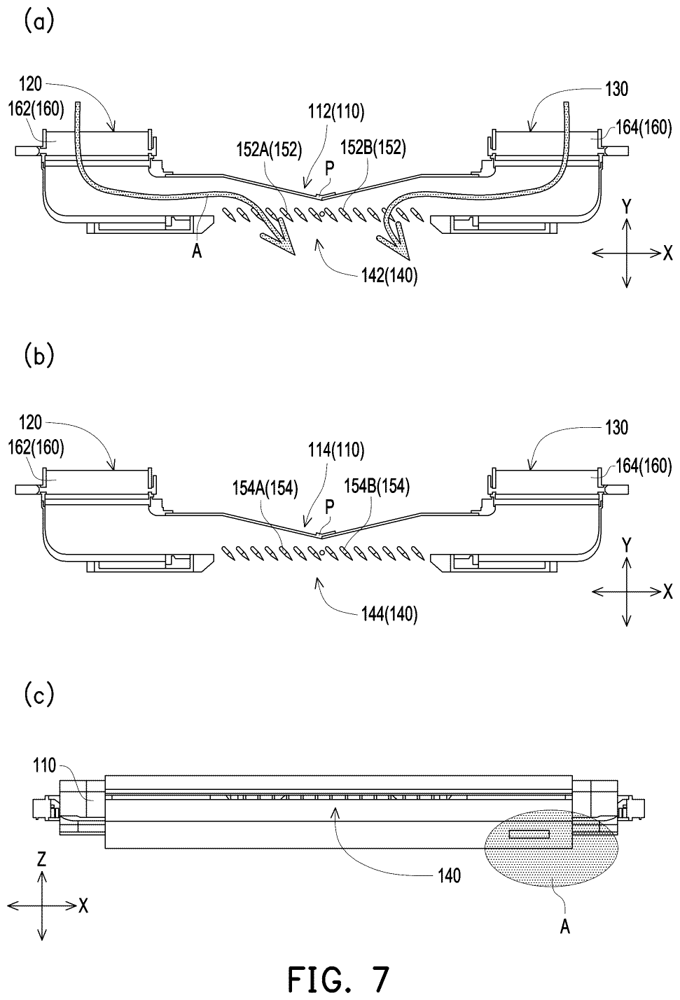

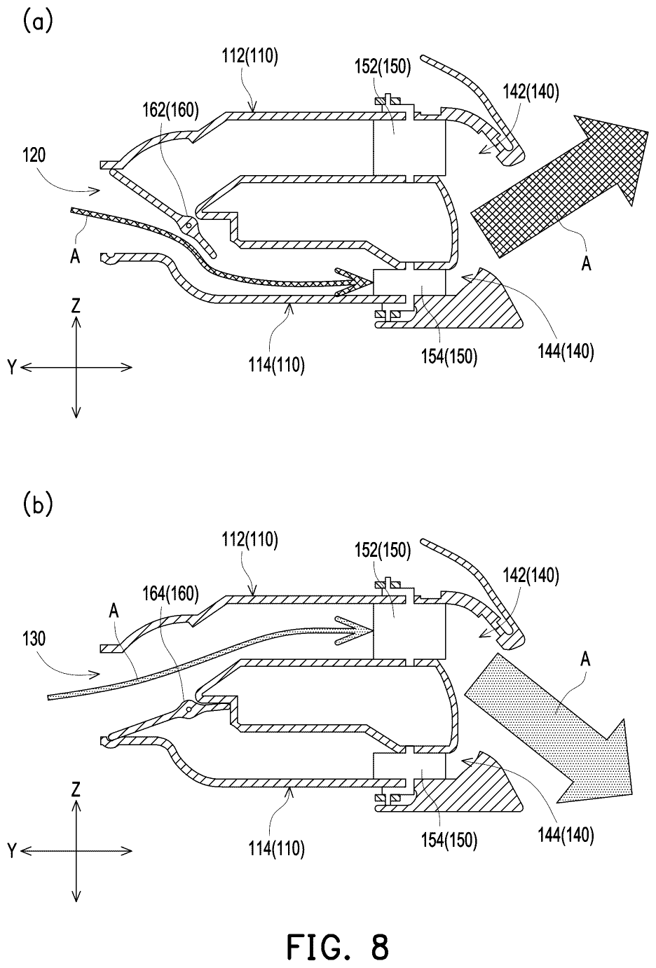

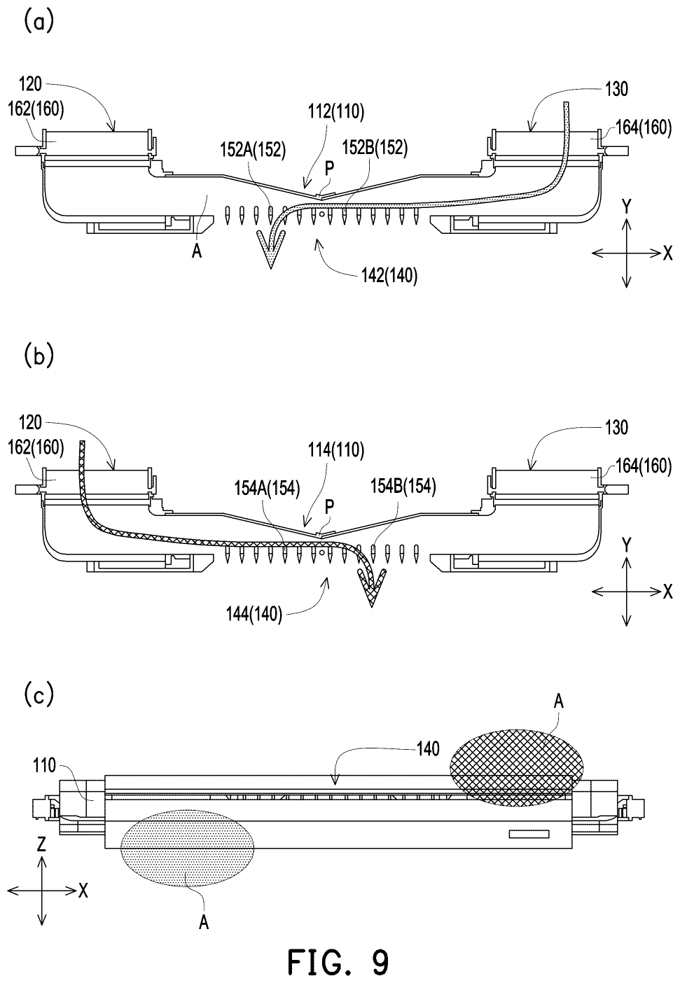

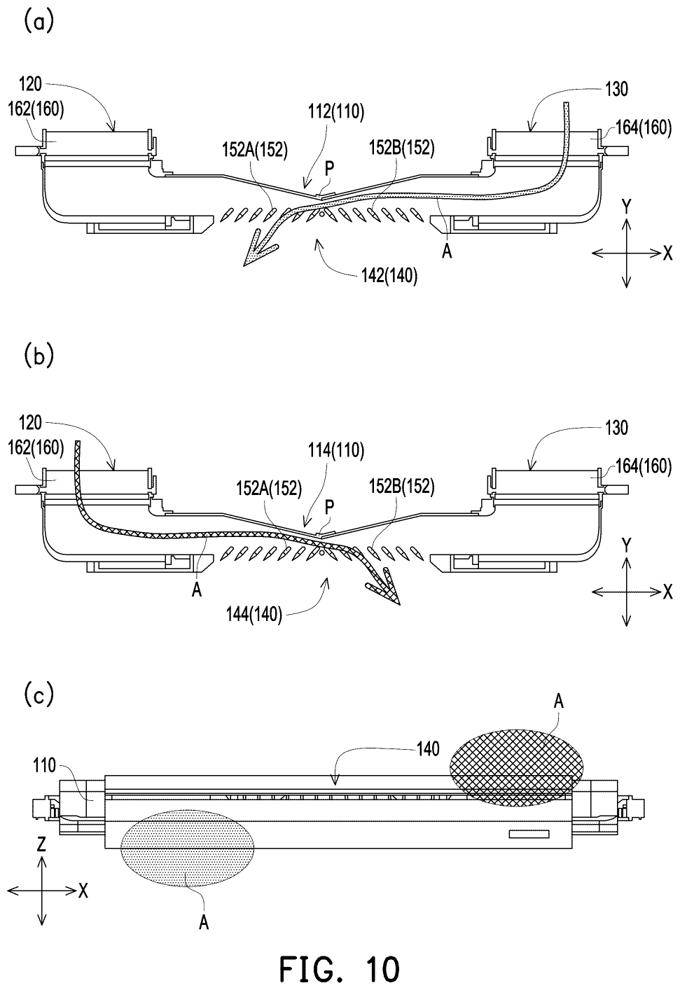

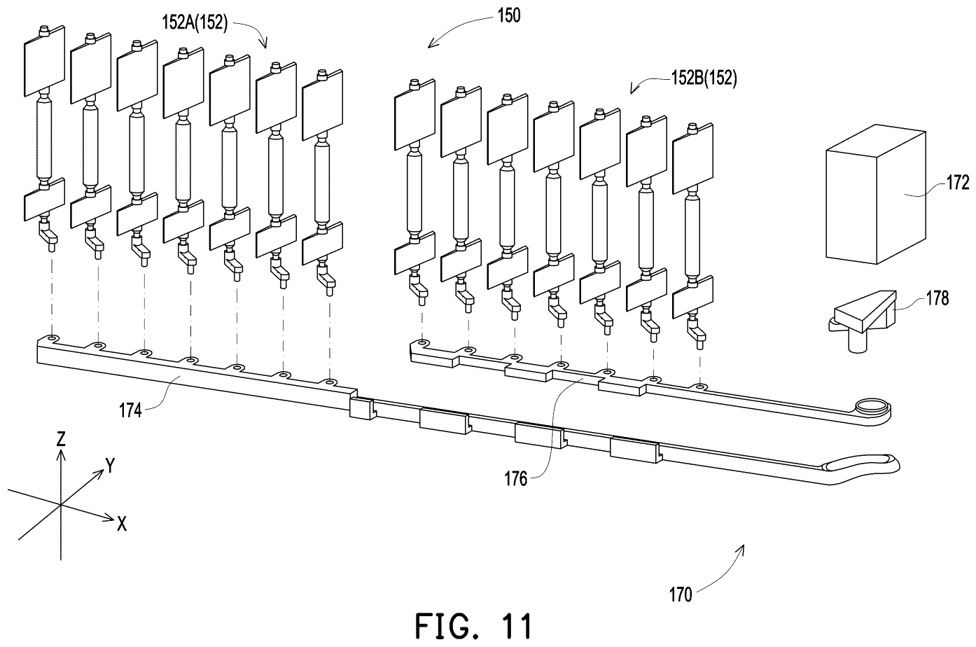

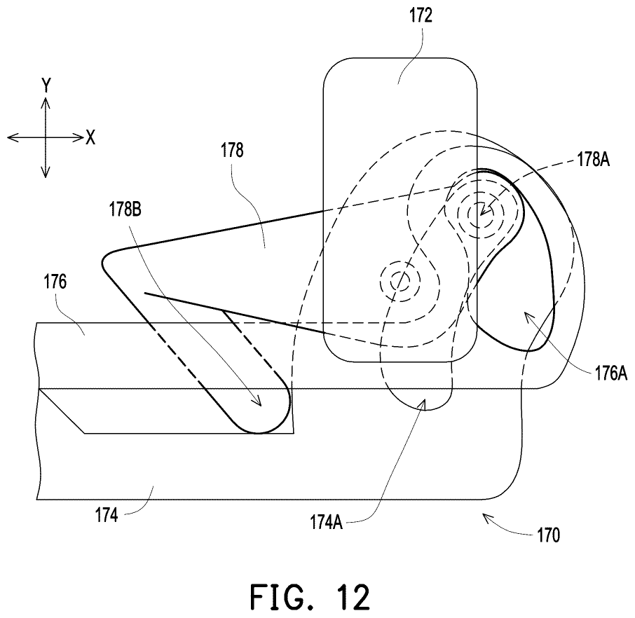

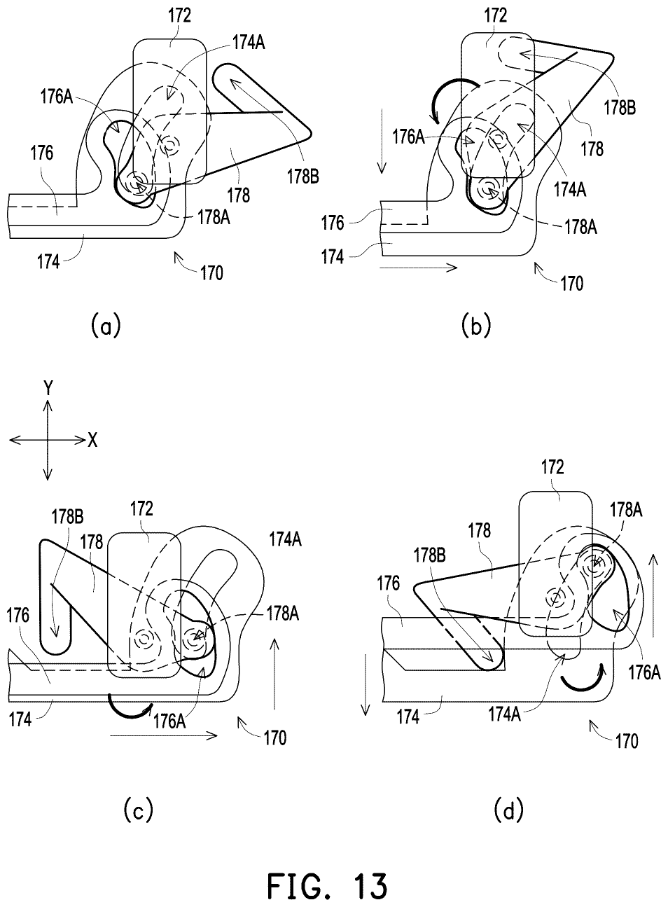

FIG. 1 is a schematic perspective view of an air passage structure according to an embodiment of the disclosure. (a) of FIG. 2 and (b) of FIG. 2 are schematic cross-sectional views of the air passage structure of FIG. 1 along the B-B and C-C section lines, respectively. (a) of FIG. 3 and (b) of FIG. 3 are top views of the first ventilation path and the second ventilation path in the air passage structure of FIG. 1, and (c) of FIG. 3 is a front view of the air passage structure of FIG. 1. FIG. 4 is a schematic view of the movable mechanism of FIG. 3 after movement. FIG. 5 and FIG. 6 are schematic views of the adjustment mechanism of FIG. 2 and FIG. 3 after movement. FIG. 7 is a schematic view of the movable mechanism of FIG. 6 after movement. FIG. 8 and FIG. 9 are schematic views of the adjustment mechanism of FIG. 2 and FIG. 3 after movement. FIG. 10 is a schematic view of the movable mechanism of FIG. 9 after movement. FIG. 11 is a schematic exploded view of the movable mechanism used in the air passage structure of FIG. 1. FIG. 12 is a partial enlarged schematic view of the movable mechanism of FIG. 11. FIG. 13 is a schematic view of an operating state of the movable mechanism of FIG. 12. In the present embodiment, an air passage structure 100 is used, for example, to introduce cold air or hot air from an air conditioner (not shown) into a vehicle interior, and particularly disposed in front of the driver's seat (not shown) to supply cold or hot air to the driver. However, the disclosure is not limited thereto, and may also be applied to other passage structures adapted for controlling air outlet. A left-right direction X, a front-back direction Y, and an up-down direction Z in the drawings are not intended to limit the positional relationship of the components in the disclosure. Whenever possible, the same referential numerals are used in the drawings and the description to refer to the same or like parts. The air passage structure 100 of the embodiment will be described below with reference to FIG. 1 to FIG. 13.

Referring to FIG. 1 to FIG. 3, in the present embodiment, the air passage structure 100 includes a ventilation path 110, an inlet portion 120, an inlet portion 130, an outlet portion 140, and a movable mechanism 150 (see FIG. 2). The ventilation path 110 extends along the left-right direction X (e.g., the vehicle width direction, but the disclosure is not limited thereto) and is substantially formed in a rectangular parallelepiped shape, but may also be formed in other shapes adapted for the flow of air A. The inlet portion 120 and the inlet portion 130 are disposed at both ends of the ventilation path 110 in the left-right direction X, so that the air A may enter the ventilation path 110. The opening of the inlet portion 120 is, for example, opened along the front-back direction Y to introduce the air A, but in other embodiments not shown, it may also be opened in the up-down direction Z, and the disclosure is not limited thereto. The outlet portion 140 is disposed between the pair of inlet portions 120 and 130 in the ventilation path 110, so that the air A may exit the ventilation path 110. More specifically, the outlet portion 140 is disposed at the back of the ventilation path 110 in the front-back direction Y (close to the inner side of the vehicle interior), and the air A entering from the inlet portion 120 and the inlet portion 130 on the left and right sides merges at a position near the outlet portion 140 in the ventilation path 110 to form a confluence portion.

Furthermore, the movable mechanism 150 is disposed at the outlet portion 140, and may change the flow direction of the air A from the front-back direction Y to the left-right direction X. In detail, the movable mechanism 150 is, for example, a blade, which rotates with the up-down direction Z as the rotation axis, and may be disposed without being exposed at the outlet portion 140 (the so-called exposure means that the movable mechanism 150 may be observed from the inside of the vehicle interior). However, the disclosure is not limited thereto, and the movable mechanism 150 may also be disposed inside the outlet portion 140 as long as the flow direction of the air A may be controlled. Preferably, the movable mechanism 150 is disposed between the confluence portion and the outlet portion 140.

It can be seen that in the air passage structure 100 of the embodiment, the outlet portion 140 is disposed between the pair of inlet portions 120 and 130 in the ventilation path 110, and the outlet portion 140 is disposed with the movable mechanism 150 to reliably control the flow direction of the air A in the left-right direction X. Furthermore, the space between the pair of inlet portions 120 and 130 and outside the ventilation path 110 may be used to place components not related to air conditioning, thereby increasing the space and degree of freedom for component configuration. Accordingly, the air passage structure 100 of the present embodiment may well control the wind direction and improve the degree of freedom of internal component configuration.

Specifically, in the present embodiment, the ventilation path 110 includes at least two ventilation paths, a first ventilation path 112 and a second ventilation path 114, and an adjustment mechanism 160 for adjusting the amount of air entering the first ventilation path 112 and the second ventilation path 114. The adjustment mechanism 160 is, for example, a blade, and rotates with the left-right direction X as the axial direction. The pair of inlet portions 120 and 130 are each disposed with the adjustment mechanism 160. The adjustment mechanism 160 may be linked to synchronously move the pair of inlet portions 120 and 130. Alternatively, a first adjustment mechanism 162 and a second adjustment mechanism 164 may be independently and separately disposed at the inlet portion 120 and the inlet portion 130 and independently actuated, and the disclosure is not limited thereto.

Next, as the adjustment mechanism 160 rotates, the opening sizes of the inlet portion 120 and the inlet portion 130 are adjusted, thereby controlling the amount of air entering the first ventilation path 112 and the second ventilation path 114. The outlet portion 140 includes a first outlet 142 disposed in the first ventilation path 112 and a second outlet 144 disposed in the second ventilation path 114. The first outlet 142 and the second outlet 144 are disposed to overlap in the up-down direction Z that is orthogonal to the left-right direction X and the direction in which the air A exits from the outlet portion 140 (that is, the front-back direction Y). Furthermore, the movable mechanism 150 includes a first movable mechanism 152 disposed in the first ventilation path 112 and a second movable mechanism 154 disposed in the second ventilation path 114. That is, the wind direction of the air A in the left-right direction X may be controlled by the first movable mechanism 152 and the second movable mechanism 154. Next, as shown in FIG. 2, the first ventilation path 112 is disposed at the upper side in the up-down direction Z, the second ventilation path 114 is disposed at the lower side in the up-down direction Z, and the air A exiting from the first outlet 142 and the air A exiting from the second outlet 144 merge at the back of the movable mechanism 150 in the front-back direction Y (i.e., close to the inner side of the vehicle interior).

In this way, the present embodiment can control the amount of air of the first ventilation path 112 and the second ventilation path 114 through the adjustment mechanism 160. When the amount of air of the first ventilation path 112 is large, the air A exiting from the outlet portion 140 is discharged downward in the up-down direction Z. On the contrary, when the amount of air of the second ventilation path 114 is large, the air A exiting from the outlet portion 140 is discharged upward in the up-down direction Z, so as to achieve the function of controlling the wind direction in the up-down direction Z. Furthermore, in conjunction with the movable mechanism 150 controlling the wind direction in the left-right direction X, the air passage structure 100 of the embodiment may control the air A to be discharged in any direction within a 360-degree circle.

Taking FIG. 2 and FIG. 3 as examples, the movable mechanism 150 is arranged in the direction of the front-back direction Y, and the adjustment mechanism 160 is also arranged in the direction of the front-back direction Y. Therefore, the amount of air of the first ventilation path 112 and the second ventilation path 114 are balanced, and as shown in (c) of FIG. 3, the air A is evenly discharged from the outlet portion 140 in the front-back direction Y.

In addition, in the present embodiment, the movable mechanism 150 includes a first movable portion 152A of the first movable mechanism 152 and a first movable portion 154A of the second movable mechanism 154 disposed on one side in the left-right direction X, and a second movable portion 152B of the first movable mechanism 152 and a second movable portion 154B of the second movable mechanism 154 disposed on the other side. As shown in FIG. 4, taking the first movable mechanism 152 as an example, the first movable portion 152A and the second movable portion 152B respectively discharge the air A in different directions. The first movable portion 152A deflects toward the left side in the left-right direction X, and the second movable portion 152B deflects toward the right side in the left-right direction X. Furthermore, taking the second movable mechanism 154 as an example, the first movable portion 154A deflects toward the right side in the left-right direction X, and the second movable portion 154B deflects toward the left side in the left-right direction X.

That is to say, by making the first movable portion 152A and the second movable portion 152B and the first movable portion 154A and the second movable portion 154B respectively discharge air in different directions, the air A may be controlled to be discharged in a concentrated manner (as shown in (b) of FIG. 4) or diffused manner (as shown in (a) of FIG. 4), and the first movable mechanism 152 and the second movable mechanism 154 may also be individually controlled to blow in different directions. As shown in (c) of FIG. 4, the first outlet 142 of the first ventilation path 112 allows the air A to be discharged downward, the second outlet 144 of the second ventilation path 114 allows the air A to be discharged upward, the first movable mechanism 152 of the first ventilation path 112 diffuses the air A (i.e., blows it toward both sides in the left-right direction X), and the second movable mechanism 154 of the second ventilation path 114 concentrates the air A (i.e., blows it toward the center in the left-right direction X). Such a configuration allows the air A to respectively blow toward the driver's face and the hands holding both sides of the steering wheel, thereby achieving the effect of cooling or warming the driver.

Preferably, in the present embodiment, the ventilation path 110 is formed with a convex portion P protruding toward the outlet portion 140. Thus, the air A may be more easily guided to the outlet portion 140, and the flow of the air A in the left-right direction X is controlled by the movable mechanism 150. In the left-right direction X, the vertex of the convex portion P serves as a boundary position that divides the first movable portion 152A and the second movable portion 152B, and the first movable portion 154A and the second movable portion 154B. In this way, the air A entering from both sides of the left-right direction X is guided along the convex portion P and reaches the vertex for diversion, and then the wind direction is more easily controlled through more finely controlling the first movable portion 152A and the second movable portion 152B, and the first movable portion 154A and the second movable portion 154B.

Referring to FIG. 5 to FIG. 7, in the present embodiment, the movable mechanism 150 is arranged in the direction of the front-back direction Y, and the adjustment mechanisms 160 of the inlet portion 120 and the inlet portion 130 are respectively deflected downward in the up-down direction Z to close the port of the second ventilation path 114. Therefore, in this case, the air A may only enter the first ventilation path 112, and then is discharged downward in the up-down direction Z when exiting the outlet portion 140 (see FIG. 5 and (c) of FIG. 6). In the case of FIG. 7, the movable mechanism 150 is further deflected toward the right side in the left-right direction X. As shown in FIG. Therefore, as shown in (c) of FIG. 7, the air A exiting from the first ventilation path 112 is blown downward in the up-down direction Z and to the right in the left-right direction X.

Referring to FIG. 8 to FIG. 10, in the present embodiment, the inlet portion 120 and the inlet portion 130 are respectively disposed with the first adjustment mechanism 162 and the second adjustment mechanism 164 that may operate independently. One of the adjustment mechanisms 160 (for example, the second adjustment mechanism 164 of the inlet portion 130 in FIG. 8) of the pair of inlet portions 120 and 130 makes the air A entering the first ventilation path 112 larger than the air A entering the second ventilation path 114, while the other adjustment mechanism 160 of the pair of inlet portions 120 and 130 (for example, the first adjustment mechanism 162 of the inlet portion 120 in FIG. 8) makes the air A entering the first ventilation path 112 smaller than the air A entering the second ventilation path 114. Therefore, as shown in (a) of FIG. 9 and (b) of FIG. 9, the first ventilation path 112 has only the air A entering from the right side (the inlet portion 130), which moves along the convex portion P of the first ventilation path 112 and flows out toward the left side without receiving resistance from the air A from the left side; likewise, the second ventilation path 114 has only the air A entering from the left side (the inlet portion 120), which moves along the convex portion P of the second ventilation path 114 and flows out toward the right side without receiving resistance from the air A from the right side. Furthermore, as shown in (c) of FIG. 9, the air A exiting from the first ventilation path 112 is discharged to the lower side in the up-down direction Z and to the left side in the left-right direction X, and the air exiting from the second ventilation path 114 is discharged upward in the up-down direction Z and to the right side in the left-right direction X. It can be seen from this that by adjusting the amount of air of the two inlets to be different, it is possible to allow the air to be discharged in two completely opposite directions in the same air passage structure 100.

As shown in FIG. 10, further, the embodiment may further improve the concentration of the air A by offsetting the first movable portion 152A and the second movable portion 152B, and the first movable portion 154A and the second movable portion 154B. The first movable portion 152A of the first ventilation path 112 discharges the air A toward one side in the left-right direction X (toward the left side as shown in (a) of FIG. 10), and the second movable portion 152B of the first ventilation path 112 allows the air A to be discharged toward the other side in the left-right direction X (toward the right side as shown in (a) of FIG. 10); the first movable portion 154A of the second ventilation path 114 discharges the air A toward one side in the left-right direction X (toward the left side as shown in (b) of FIG. 10), and the second movable portion 154B of the second ventilation path 114 discharges the air A toward the other side in the left-right direction X (toward the right side as shown in (b) of FIG. 10). Thus, the air A entering from the inlet portion 130 moves along the first ventilation path 112 and follows the convex portion P toward the left side in the left-right direction X to enter the first movable portion 152A; the air A entering from the inlet portion 120 moves along the second ventilation path 114, and follows the convex portion P toward the right side in the left-right direction X to enter the second movable portion 154B.

Compared with the embodiment of FIG. 9, such a configuration may better concentrate the air A to be discharged in the desired direction. Preferably, in the viewing angle of the up-down direction Z, the first movable portion 152A and the second movable portion 152B are formed in a figure eight shape, and the first movable portion 154A and the second movable portion 154B are formed in a figure eight shape. In this way, when the air A flows through the second movable portion 152B in the first ventilation path 112 and flows through the first movable portion 154A in the second ventilation path 114, leakage of the air A may be reduced.

In the present embodiment, by changing the directions of the movable mechanism 150 and the adjustment mechanism 160, the function of controlling the air A to be discharged in any direction (as shown in FIG. 3, FIG. 6, and FIG. 7), two opposite directions (as shown in FIG. 9 and FIG. 10), or even three directions (as shown in FIG. 4) may be achieved. The disclosure is not limited to the above-described implementation methods. To avoid the specification being cumbersome, the implementation methods of other wind directions will not be described in detail. Those skilled in the art should be able to infer the implementation methods of other air passage structures 100 from the above-mentioned contents.

Furthermore, in the present embodiment, referring to FIG. 11 and FIG. 12, the first movable portions 152A and 154A and the second movable portions 152B and 154B of the movable mechanism 150 (including the first movable mechanism 152 and the second movable mechanism 154) are driven by a single driving mechanism. Here, taking the first movable mechanism 152 (as shown in FIG. 2 to FIG. 10) disposed in the first ventilation path 112 as an example, the first movable portion 152A and the second movable portion 152B of the first movable mechanism 152 are driven by a single driving mechanism 170. In this way, the first movable portion 152A and the second movable portion 152B are driven by the single driving mechanism 170 to move as described above, thereby simplifying the structure and reducing the cost. Similarly, the second movable mechanism 154 (as shown in FIG. 2 to FIG. 10) disposed in the second ventilation path 114 may also be configured such that the first movable portion 154A and the second movable portion 154B are driven by a single driving mechanism (which may be the driving mechanism 170 of the same structure but is not limited thereto). The following describes a driving process of the first movable mechanism 152 by the driving mechanism 170, and the description may also be applied to the second movable mechanism 154 but is not limited thereto.

Specifically, as shown in FIG. 11 and FIG. 12, the driving mechanism 170 includes a driving motor 172, a first link 174 connected to the first movable portion 152A, a second link 176 connected to the second movable portion 152B, and an engaging member 178 that engages with the first link 174 and the second link 176 and is rotated by the driving motor 172. The driving motor 172 is disposed adjacent to the engaging member 178 and is connected to the engaging member 178 via a driving shaft to drive the engaging member 178 to rotate. Also, since the first movable portion 152A includes a plurality of blades disposed on one side (e.g., the left side in the drawing) in the left-right direction X and arranged at intervals from each other, and the second movable portion 152B includes a plurality of blades disposed on the other side (e.g., the right side in the drawing) in the left-right direction X and arranged at intervals from each other, the first link 174 is preferably a strip-shaped bar extending along the left-right direction X and connecting the plurality of blades as the first movable portion 152A, and the second link 176 is preferably a strip-shaped bar extending along the left-right direction X and connecting the plurality of blades as the second movable portion 152B. The first link 174 extends further to one side in the left-right direction X (for example, the left side in the drawing) than the second link 176, and the ends of the first link 174 and the second link 176 located on the other side in the left-right direction X (e.g., the right side in the drawing) are connected to the driving motor 172 via the engaging member 178. In this way, the driving mechanism 170 may drive the first link 174 and the second link 176 by the actuation of the driving motor 172 and the rotation of the engaging member 178. Thus, the first movable portion 152A and the second movable portion 152B are driven respectively by the first link 174 and the second link 176 to perform the same or different movements (for example, respectively discharging air in different directions as mentioned above).

More specifically, in the present embodiment, as shown in FIG. 12, the engaging member 178 includes a first engaging portion 178A that engages with the first link 174 and the second link 176, and a second engaging portion 178B that engages only with the first link 174. That is, the first engaging portion 178A is engaged with both the first link 174 and the second link 176, but the second engaging portion 178B is only engaged with the first link 174 and not engaged with the second link 176. In this way, the driving mechanism 170 may drive the first link 174 and the second link 176 to move in the same manner through the first engaging portion 178A, and may drive the first link 174 and the second link 176 to move differently through the second engaging portion 178B. Accordingly, the first link 174 has a first groove 174A for the first engaging portion 178A (engaging protrusion) to be inserted into, and the second link 176 has a second groove 176A for the first engaging portion 178A to be inserted into. The length of the first groove 174A is longer than the length of the second groove 176A. In this way, when the driving mechanism 170 drives the first link 174 to move independently of the first engaging portion 178A via the second engaging portion 178B, the first engaging portion 178A may slide relative to the first groove 174A without affecting the movement of the first link 174. However, the disclosure does not limit the specific structure of the driving mechanism 170, and the disclosure does not exclude the use of multiple driving mechanisms to drive the first movable portion 152A and the second movable portion 152B respectively, which may be adjusted according to requirements.

As an example, FIG. 13 illustrates a driving method of the driving mechanism 170 driving the first movable portion 152A and the second movable portion 152B. The driving mechanism 170 may be selectively switched to one of the states shown in FIG. 13 according to requirements. The first movable portion 152A and the second movable portion 152B are omitted here, and may be considered together with the first movable portion 152A and the second movable portion 152B shown in FIG. 2 to FIG. 10 and the driving mechanism 170 shown in FIG. 11 and FIG. 12.

First, as shown in (a) of FIG. 13, the first link 174 and the second link 176 overlap each other, the first engaging portion 178A of the engaging member 178 is located at the terminal of the first groove 174A and the terminal of the second groove 176A, and the second engaging portion 178B of the engaging member 178 is located on the outside and does not contact the first link 174 and the second link 176. At this time, the first movable portion 152A connected to the first link 174 (shown in FIG. 11 and FIG. 12) and the second movable portion 152B (shown in FIG. 11 and FIG. 12) connected to the second link 176 is, for example, in a closed state (the blades of the first movable portion 152A and the second movable portion 152B are shielded and not open).

Next, as shown in (b) of FIG. 13, the engaging member 178 is driven by the driving motor 172 to rotate in the counterclockwise direction around the driving shaft (as shown by the arrow) relative to the stationary driving motor 172 (that is, the driving motor 172 is used as a reference). The first engaging portion 178A pushes the side walls of the first groove 174A and the second groove 176A to move the first link 174 and the second link 176 to the lower side and to the right side in the drawing. At this time, the first movable portion 152A connected to the first link 174 (shown in FIG. 11 and FIG. 12) and the second movable portion 152B connected to the second link 176 (shown in FIG. 11 and FIG. 12) are driven to move by the first link 174 and the second link 176 moving to the lower side and to the right side in the drawing, such that the blades of the first movable portion 152A and the second movable portion 152B are moved to change directions, for example, to be in a left air distribution state (the blades of the first movable portion 152A and the second movable portion 152B are opened toward the left).

Next, as shown in (c) of FIG. 13, the engaging member 178 continues to rotate in the counterclockwise direction around the driving shaft (as shown by the arrow) relative to the stationary driving motor 172. The first engaging portion 178A pushes the side walls of the first groove 174A and the second groove 176A to move the first link 174 and the second link 176 toward the right side and toward the upper side in the drawing. At this time, the first movable portion 152A connected to the first link 174 (shown in FIG. 11 and FIG. 12) and the second movable portion 152B (shown in FIG. 11 and FIG. 12) connected to the second link 176 are driven to move by the first link 174 and the second link 176 moving toward the right side and toward the upper side in the drawing, such that the blades of the first movable portion 152A and the second movable portion 152B are moved to change directions, for example, to be in a right air distribution state (the blades of the first movable portion 152A and the second movable portion 152B are opened toward the right).

Finally, as shown in (d) of FIG. 13, the engaging member 178 continues to rotate in the counterclockwise direction around the driving shaft (as shown by the arrow) relative to the stationary driving motor 172. The second engaging portion 178B extends obliquely toward the inner side in the drawing to bypass the second link 176 and only push the first link 174, so that the first link 174 moves toward the lower side in the drawing, and the first engaging portion 178A moves toward the upper side in the drawing along the first groove 174A and the second groove 176A. At this time, since the length of the first groove 174A is longer than the length of the second groove 176A, when the driving mechanism 170 drives the first link 174 to move independently of the first engaging portion 178A through the second engaging portion 178B, the first engaging portion 178A may slide relative to the first groove 174A without affecting the movement of the first link 174 toward the lower side in the drawing. The second engaging portion 178B of the engaging member 178 is inclined and extends further toward the inner side in the drawing than other parts of the engaging member 178 (e.g., the main body and the first engaging portion 178), and is located at a different level relative to other parts. Therefore, the engaging member 178 may push only the first link 174 on the inner side of the second link 176 in the drawing with the second engaging portion 178B in a state where the other parts are disposed at the front side of the second link 176 in the drawing. However, when the configuration of the driving mechanism 170 is different from the configuration described in the present embodiment, the specific shapes and connection relationships of the components may be adjusted according to requirements. In this way, the first movable portion 152A (shown in FIG. 11 and FIG. 12) connected to the first link 174 is driven to move by the first link 174 moving toward the lower side in the drawing, and the second movable portion 152B (shown in FIG. 11 and FIG. 12) connected to the second link 176 is driven to move by the second link 176 moving toward the upper side in the drawing, such that the blades of the first movable portion 152A and the second movable portion 152B are moved to change directions, for example, to be in a diffuse state (the blades of the first movable portion 152A are opened to the left and the blades of the second movable portion 152B are opened to the right).

With the above configuration, the driving mechanism 170 may drive the first link 174 and the second link 176 by the actuation of the driving motor 172 and the rotation of the engaging member 178. In particular, the first link 174 and the second link 176 are moved in the same direction by the first engaging portion 178A, and the first link 174 and the second link 176 are moved in different directions by the second engaging portion 178B. Thus, the first movable portion 152A and the second movable portion 152B may be driven respectively by the first link 174 and the second link 176 to perform the same or different movements (for example, respectively discharging air in different directions as mentioned above). The driving mechanism 170 may be selectively switched to one of the states shown in FIG. 13 according to requirements. For example, the movable mechanism 150 may be in the closed state shown in (a) of FIG. 13 at present, the driving mechanism 170 is driven to adjust to the right air distribution state shown in (c) of FIG. 13, and the driving mechanism 170 is driven to adjust to the left air distribution state shown in (b) of FIG. 13 when the diffuser state is currently shown in (d) of FIG. 13. In this way, the air passage structure 100 may control the wind direction well and improve the degree of freedom of internal component configuration. However, the disclosure does not limit the operating method of the driving mechanism 170, which may be adjusted according to requirements.

In summary, in the air passage structure of the disclosure, the outlet portion is disposed between a pair of inlet portions in the ventilation path, and the outlet portion is disposed with a movable mechanism to reliably control the flow direction of air in the first direction. Furthermore, the space between the pair of inlet portions and outside the ventilation path may be used to place components not related to air conditioning, thereby increasing the space and degree of freedom for component configuration. Preferably, the ventilation path includes at least two ventilation paths, a first ventilation path and a second ventilation path, and an adjustment mechanism for adjusting the amount of air entering the two ventilation paths. The first outlet disposed in the first ventilation path and the second outlet disposed in the second ventilation path are disposed to overlap in the second direction, thereby being able to control the up-down and left-right air outlet directions. Furthermore, the first movable portion and the second movable portion of the movable mechanism may be driven by a single driving mechanism to perform the same or different movements, thereby simplifying the structure and reducing costs. Accordingly, the air passage structure of the disclosure may well control the wind direction and improve the degree of freedom of internal component configuration.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. An air passage structure, comprising:
a ventilation path, extending along a first direction;
a pair of inlet portions, disposed in the ventilation path to allow air to enter the ventilation path;
an outlet portion, disposed between the pair of inlet portions in the ventilation path to allow the air to exit the ventilation path; and
a movable mechanism, disposed at the outlet portion, and being movable toward the first direction.

2. The air passage structure according to claim 1, wherein
the ventilation path comprises at least two ventilation paths, a first ventilation path and a second ventilation path, and an adjustment mechanism for adjusting an amount of air entering the first ventilation path and the second ventilation path,
the outlet portion comprises a first outlet disposed in the first ventilation path and a second outlet disposed in the second ventilation path, and
the first outlet and the second outlet are disposed to overlap in a second direction orthogonal to the first direction and a direction in which the air exits from the outlet portion.

3. The air passage structure according to claim 2, wherein
the pair of inlet portions are respectively disposed with the adjustment mechanism, and
the adjustment mechanism of one of the pair of inlet portions makes the air entering the first ventilation path larger than the air entering the second ventilation path, while the adjustment mechanism of the other of the pair of inlet portions makes the air entering the first ventilation path smaller than the air entering the second ventilation path.

4. The air passage structure according to claim 1, wherein
the movable mechanism comprises a first movable portion disposed on one side in the first direction and a second movable portion disposed on the other side,
the first movable portion and the second movable portion face different directions respectively.

5. The air passage structure according to claim 2, wherein
the movable mechanism comprises a first movable portion disposed on one side in the first direction and a second movable portion disposed on the other side,
the first movable portion and the second movable portion face different directions respectively.

6. The air passage structure according to claim 3, wherein
the movable mechanism comprises a first movable portion disposed on one side in the first direction and a second movable portion disposed on the other side,
the first movable portion and the second movable portion face different directions respectively.

7. The air passage structure according to claim 5, wherein
the first outlet of the first ventilation path faces downward, the second outlet of the second ventilation path faces upward, and
the movable mechanism of the first ventilation path diffuses the air, and the movable mechanism of the second ventilation path concentrates the air.

8. The air passage structure according to claim 6, wherein
the first movable portion of the first ventilation path faces the one side in the first direction, and the second movable portion of the first ventilation path faces the other side in the first direction,
the first movable portion of the second ventilation path faces the one side in the first direction, and the second movable portion of the second ventilation path faces the other side in the first direction.

9. The air passage structure according to claim 4, wherein
the first movable portion and the second movable portion are driven by a single driving mechanism.

10. The air passage structure according to claim 9, wherein
the driving mechanism comprises a driving motor, a first link connected to the first movable portion, a second link connected to the second movable portion, and an engaging member engaged with the first link and the second link and rotated by the driving motor.

11. The air passage structure according to claim 10, wherein
the engaging member comprises a first engaging portion that engages with the first link and the second link, and a second engaging portion that engages only with the first link.

12. The air passage structure according to claim 11, wherein
the first link has a first groove for the first engaging portion to be inserted into,
the second link has a second groove for the first engaging portion to be inserted into, and
a length of the first groove is longer than a length of the second groove.

13. The air passage structure according to claim 4, wherein
the ventilation path is formed with a convex portion protruding toward the outlet portion, and
a vertex of the convex portion serves as a boundary position that divides the first movable portion and the second movable portion in the first direction.

14. The air passage structure according to claim 5, wherein
the ventilation path is formed with a convex portion protruding toward the outlet portion, and
a vertex of the convex portion serves as a boundary position that divides the first movable portion and the second movable portion in the first direction.

15. The air passage structure according to claim 6, wherein
the ventilation path is formed with a convex portion protruding toward the outlet portion, and
a vertex of the convex portion serves as a boundary position that divides the first movable portion and the second movable portion in the first direction.

16. The air passage structure according to claim 7, wherein
the ventilation path is formed with a convex portion protruding toward the outlet portion, and
a vertex of the convex portion serves as a boundary position that divides the first movable portion and the second movable portion in the first direction.

17. The air passage structure according to claim 8, wherein
the ventilation path is formed with a convex portion protruding toward the outlet portion, and
a vertex of the convex portion serves as a boundary position that divides the first movable portion and the second movable portion in the first direction.

18. The air passage structure according to claim 9, wherein
the ventilation path is formed with a convex portion protruding toward the outlet portion, and
a vertex of the convex portion serves as a boundary position that divides the first movable portion and the second movable portion in the first direction.

19. The air passage structure according to claim 10, wherein
the ventilation path is formed with a convex portion protruding toward the outlet portion, and
a vertex of the convex portion serves as a boundary position that divides the first movable portion and the second movable portion in the first direction.

20. The air passage structure according to claim 11, wherein
the ventilation path is formed with a convex portion protruding toward the outlet portion, and
a vertex of the convex portion serves as a boundary position that divides the first movable portion and the second movable portion in the first direction.
